(19) United States
(12) Patent Application Publication
(10) Pub. No.: US 2007/0187514 A1
(43) Pub. Date: Aug. 16, 2007

(54) IDENTIFICATION MARK READING METHOD AND APPARATUS FOR THE SAME

(75) Inventor: Masaharu Sasaki, Okuchi-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: Yamaha Corporation, Hamamatsu-Shi (JP)

(21) Appl. No.: 11/616,153

(22) Filed: Dec. 26, 2006

(30) Foreign Application Priority Data
Dec. 27, 2005 (JP) P2005-375835

(51) Int. Cl. G06K 7/10

(52) U.S. Cl. 235/462.39

(57) ABSTRACT

A reading method and a reading apparatus of an identification mark can read the identification mark even if a principle surface of a wafer on which the identification mark is formed is molded with a resin. In order to achieve this object, a reading apparatus (A) of an identification mark (20) includes: a lighting unit (13) which has a light source (10) that radiates infrared; and an imaging unit (16) which takes an image by receiving reflected light of the infrared radiated on a wafer (1), and the identification mark (20) formed on a principle surface (1c) of the wafer (1) is read by: radiating the infrared from a back face (1b) of the wafer (1) so as to cross an optical axis on the principle surface (1c) of the wafer (1); and taking an image along with receiving reflected light of the infrared after transmitting through the wafer (1) and reflecting on a side of the principle surface.

### BACKGROUND OF THE INVENTION

1. Field of the Invention

The present invention relates to an identification mark, such as a wafer number, a lot number or the like formed on a wafer, reading method and an identification mark reading apparatus.

Priority is claimed on Japanese Patent Application No. 2005-375835, filed Dec. 27, 2005, the content of which is incorporated herein by reference.

2. Description of the Related Art

In a factory or a workshop for producing a semiconductor device, heretofore, multiple wafers (for example, wafers of one lot) set inside a single container case are carried or transported among the steps of producing the semiconductor device. Generally, there are many production steps conducted on the wafer; therefore, an identification mark such as a product type, a type number, a lot number, a wafer number, and the like, appears on each of the wafers in order to prevent an error or a mistake by preventing confusion of the wafers because of intricacy of the production steps.

This kind of identification mark is formed on the wafer by using, for example, a laser marker or the like, and the identification mark indicates a character or a number by applying a set of carved stamps in a dotted shape. In a case in which, for example, when the back side of the wafer is adhered by suction in order to maintain or transport the wafer, if this identification mark on the back side of the wafer is formed, a protrusion or a projection is formed on a principle surface of the wafer at an opposite side corresponding to the identification mark; therefore, for example, there are cases in which a defocus in a photolithography step, a polishing error in a CMP (Chemical Mechanical Polishing) step, and the like are caused. Therefore, the identification mark is provided on the principle surface of the wafer.

When it is needed to recognize, specify, identify or detect the wafer or the lot in a production step or the like, the identification mark is detected or recognized by applying an identification mark reading apparatus provided with a CCD camera or the like. Moreover, there is an identification mark reading apparatus of this type that has a transportation robot which takes the wafer into and out of the container case; and therefore, it is possible to rearrange or reorder the multiple wafers which are identified or recognized by reading the identification mark so as to, for example, be arranged in an ascending or descending order of the identification mark (for example, see Japanese patent application, First Publication No. H05-147723).

However, with respect to the reading apparatus of the identification mark formed on the wafer, there is a problem in which if the principle surface of the wafer is resin-molded/plastic-molded by forming a resin/plastic layer along with the proceeding of production steps, it is not possible to recognize the identification mark because the identification mark formed on the principle surface is resin-molded. In other words, with respect to a production of the semiconductor device, the principle surface is resin-molded after the steps of: preparing a wafer on which multiple IC (Integrated Circuits) are formed on a side of the principle surface; forming a rewiring to which the IC is electrically connected via a pad electrode; and forming, for example, a metal post in a pillar-shape made from copper on the rewiring. Therefore, in a step before resin-molding the IC, the rewiring and the metal post, it is possible to read the identification mark formed on the principle surface of the wafer even by the naked eye because it is exposed; however, there is a problem in which the identification mark is covered with the resin after resin-molding, therefore, it is not possible to recognize or identify the wafer or the lot.

### SUMMARY OF THE INVENTION

Regarding the above-described problem, the present invention has an object to provide an identification mark reading method and an apparatus for the same that can recognize the identification mark even in a case in which the principle surface of the wafer on which the identification mark is formed is resin-molded.

In the present invention, a reading method of an identification mark which is formed on a wafer includes the steps of: radiating infrared which has an optical axis crossing the wafer from a side of a back face of the wafer on which a resin layer which molds a side of a principle surface is formed; and reading the identification mark formed on the side of the principle surface of the wafer by imaging the identification mark along with receiving reflected light of the infrared.

In the present invention, in the reading method of the identification mark above, the infrared may be radiated along with diagonally crossing the optical axis on the principle surface of the wafer.

In the present invention, a reading apparatus of an identification mark formed on a wafer including a resin layer which molds a principle surface of the wafer, includes: a lighting unit which radiates infrared; and an imaging unit which obtains an image by receiving reflected light of the infrared radiated on the wafer from the lighting unit.

In the present invention, in the reading apparatus of the identification mark above, the lighting unit may include a fiber bundle which regulates an optical path of the infrared radiated from a light source.

In the present invention, the reading apparatus of the identification mark above further may include a reflection mirror which regulates the optical path of the infrared radiated from the light source.

### BRIEF DESCRIPTION OF THE DRAWINGS

FIG. 1 is a figure which shows an identification mark reading apparatus of a first embodiment of the present invention for reading an identification mark formed on a wafer.

FIG. 2 is a side face of FIG. 1.

FIG. 3 is a figure showing a lighting unit of FIG. 2.

FIG. 4 is a figure showing one example of a wafer of a first embodiment of the present invention.

FIG. 5 is a cross section of the wafer of FIG. 4.

FIG. 6 is a figure showing a relationship between infrared irradiated onto the wafer from the reading apparatus of the identification mark of the first embodiment of the present application and reflected light.

FIG. 7 is a figure showing one example of an image obtained by the reading apparatus of the identification mark of the first embodiment of the present invention.

FIG. 8 is a figure showing a modified example of the reading apparatus of the identification mark formed on the wafer of the first embodiment of the present invention.

FIG. 9 is a figure showing a modified example of the reading apparatus of the identification mark formed on the wafer of the first embodiment of the present invention.

FIG. 10 is a figure showing the reading apparatus of the identification mark formed on the wafer of a second embodiment of the present invention.

FIG. 11 is a figure showing a relationship between infrared irradiated onto the wafer from the reading apparatus of the identification mark of the second embodiment of the present application and reflected light.

FIG. 12 is a figure showing one example of an image obtained by the reading apparatus of the identification mark of the second embodiment of the present invention.

### DETAILED DESCRIPTION OF THE INVENTION

Hereinafter, referring to FIG. 1-7, a reading method and an apparatus for the same of an identification mark formed on a wafer of a first embodiment of the present invention are explained. This embodiment relates to the reading method and the apparatus for the same for reading the identification mark formed on the wafer on which a resin layer is formed on a principle surface.

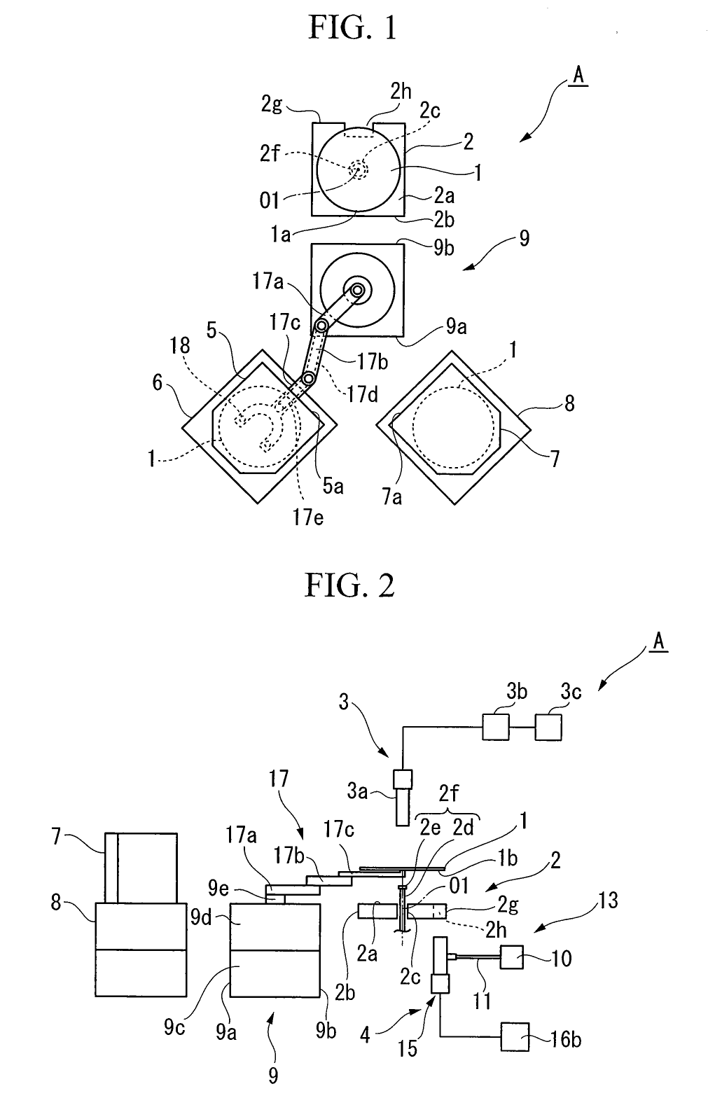

As shown in FIG. 1-2, a reading apparatus A of the identification mark (hereinafter, reading apparatus A) of the present invention is constituted from: a stage portion 2 having an upper surface 2a on which a wafer 1 is mounted; a first imaging portion 3 set at an upper side of the stage portion 2 for taking outside images of the wafer 1; a second imaging portion 4 set at a lower side of the stage portion 2 for reading the identification mark of the wafer 1; a first container case mounting table 6 on which a first container case 5 containing multiple wafers 1 inside is mounted; a second container case mounting table 8 on which a second container case 7 that can contain multiple wafers 1 inside is mounted; and a transportation portion 9 for receiving and delivering the wafer 1 between the first container case 5/second container case 7 and the stage portion 2. Here, the stage portion 2 is arranged so as to face the first container case mounting table 6 and the second container case mounting table 8 with the transportation portion 9 between.

The stage portion 2 is formed approximately in a square board shape, and approximately at a center of it, an aperture portion 2c which has a circular-shaped cross section is formed so as to pierce from an upper surface to a lower surface. Through this aperture portion 2c, a suction portion 2f which is constituted from, for example, a suction main body portion 2d and a suction pad 2e that sucks and maintains the wafer 1 at an end of the suction main body portion 2d, is inserted so as to pierce in a state in which it is possible to appear and be received/hidden and which is rotatable around an axis line 01. With respect to this suction portion 2f, an inside aperture of the suction main body portion 2d is, for example, connected to a vacuum suction means such as a vacuum pump and the suction pad 2e has a function as a sucker by setting the suction pad 2e so as to touch the back surface 1b of the wafer 1 and by driving the vacuum suction means. With respect to the stage portion 2, on a side of another side face 2g arranged at an opposite side of one side face 2b which faces the transportation portion 9, a groove (dent or concave) portion 2h which is dented in an orthogonal direction to the other side face 2g is formed. This groove portion 2h is arranged so as to overlap a portion of an outside edge of the wafer 1 which is mounted on the upper surface 2a of the stage portion 2.

As shown in FIG. 2, the first imaging portion 3 is constituted from an imaging portion 3a which is, for example, a CCD camera or the like, and a wafer position recognition apparatus 3b which is connected to the imaging portion 3a. The imaging portion 3a is arranged so as to have its optical axis crossing orthogonally to the upper surface 2a of the stage portion 2. The wafer position recognition apparatus 3b can detect a position of the wafer 1, based on an image signal from the imaging portion 3a, by detecting a position of a notch 1a which is shown in FIG. 1 and which is provided on the outside edge of the wafer 1 or a surrounding portion of the outside edge of the wafer. Moreover, a display portion 3c which is, for example, a monitor or the like is connected to the wafer position recognition apparatus 3b; therefore, it is possible to display an image of the wafer 1 obtained by the imaging portion 3a on the display portion 3c.

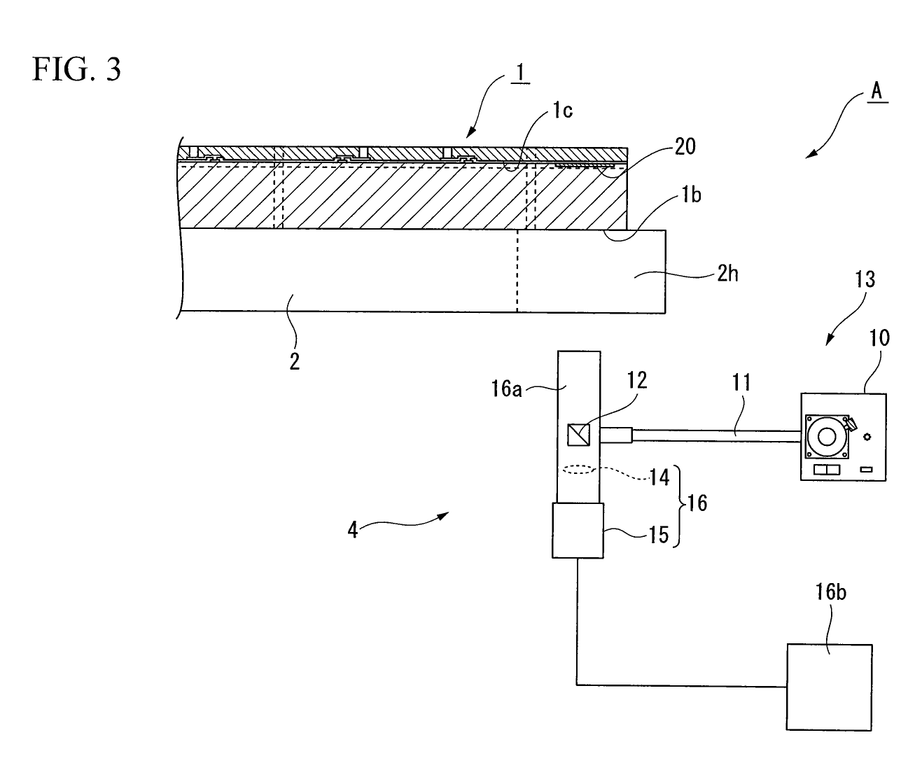

The second imaging portion 4 is constituted from, as shown in FIGS. 2 and 3 both a lighting unit 13 including: an IR (Infra-red) light source 10 (light source) which can, for example, radiate infrared longer than 1100 nm ; a fiber bundle 11 which regulates an optical path of the infrared radiated from the IR light source 10; and a reflection mirror 12 which changes a direction of the infrared radiated from an end (second end) of the fiber bundle 11, and an IR camera 16 (imaging unit) including: a lens 14; and an imaging device 15.

The IR light source 10 of the lighting unit 13 is arranged inside a case which is in a rectangular shape such as a box. The fiber bundle 11 has a first edge arranged inside the case and a second edge is extended and/or protrudes close to the reflection mirror 12 which is arranged inside the IR camera 16. This fiber bundle 11 is arranged so as to receive the infrared irradiated from the IR light source 10 from the first edge and to make the infrared received at the first edge outgo from the second edge towards the reflection mirror 12. The reflection mirror 12 is arranged inside the case 16a of the IR camera 16 which is described later, and is arranged to have its angle so as to irradiate the infrared to the wafer 1 which is set upward by changing a direction of the infrared outgoing from the second edge of the fiber bundle. Moreover, the reflection mirror 12 is a half mirror.

With respect to the IR camera 16, for example, inside the case 16a which is formed in a cylindrical shape, both the lens 14 and the imaging device 15 under the lens 14 are arranged. Moreover, wirings connected to the imaging device 15 extend or protrude outward from an lower end of the case 16a and are connected to, for example, a display portion 16b such as a monitor. The reflection mirror 12 is arranged so as to set both the optical axis of the optical system of the IR camera 16 and the optical axis of the infrared, which has a direction changed by the reflection mirror 12, on the same line, and is arranged upside of the lens 14.

As shown in FIG. 1-2, with respect to the first container case mounting table 6 and the second container case mounting table 8, the first container case 5 which can contain multiple wafers 1 is mounted on the upper surface 6a of the first container case mounting table 6, and the second container case 7 which can contain multiple wafers 1 is mounted on the upper surface 8a of the first container case mounting table 8. Here, the first container case 5 and the second container case 7 are respectively formed in an approximately rectangular box shape, and respectively have side faces 5a and 7a on which there are openings in a state in which they face the transportation portion 9 when they are respectively mounted on the first container case mounting table 6 and the second container case mounting table 8. Inside the first container case 5 and the second container case 7, multiple slots are provided in parallel or in a state of multiple layers, and the multiple wafers 1 are orderly or regularly arranged and aligned as one lot by inserting the wafers 1 respectively into the slots. Moreover, the first container case 5 and the second container case 7 can be raised and lowered by setting, for example, a driving portion to the first container case mounting table 6 and the second container case mounting table 8. A control portion which is not shown in figures is connected to this driving portion and the first container case 5 and the second container case 7 can be respectively raised and lowered for one slot in accordance with requirements.

As shown in FIG. 1-2, the transportation portion is constituted from: a XV table 9c; a rotary actuator 9d which is mounted perpendicularly upward on this XV table 9c; and an articulated arm 17 connected to an upper end of a rotation axis 9e of the rotary actuator 9d. The articulated arm 17 is constituted from a first arm 17a, a second arm 17b and a third arm 17c which are arranged horizontally parallel, and the first arm 17a has one edge which is connected to the upper edge of the rotation axis 9e and moves in accordance with a rotation of the rotation axis 9e. With respect to the second arm 17b, one edge is rotatably supported by using a shaft at another end of the first arm 17a, and it is rotatable around another end of the first arm 17a as a center by using a belt transmission apparatus 17d which is set inside the second arm 17b. With respect to the third arm 17c, one edge is rotatably supported by using a shaft at another end of the second arm 17b, and it is rotatable around another end of the second arm 17b as a center by using a belt transmission apparatus 17e which is set inside the third arm 17c. Moreover, another end of the third arm 17c is formed so as to be bifurcated, and supporting portions 18 which have a protruding shape are provided on upper surfaces of the bifurcated end. On this supporting portion 18, a vacuum suction aperture which is not shown in figures is formed, and this vacuum suction aperture is connected to and communicates with a suction path which is provided inside the third arm 17c and which is not shown in figures. A vacuum suction means, for example, a vacuum pump which is connected to the suction path.

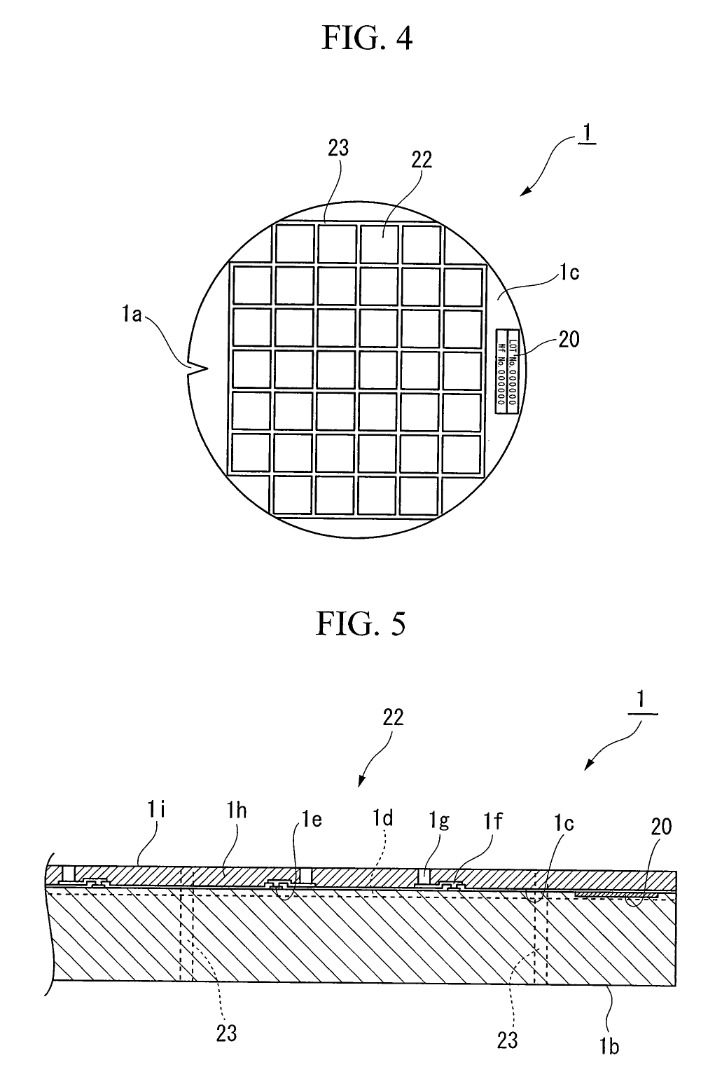

The wafer 1 of this embodiment is, for example, formed in a disc shape and is made from, for example, a poly-crystal or single-crystal silicon, and as shown in FIG. 4-5, on a principle surface 1c, an IC (Integrated Circuit) 1d, a rewiring 1f which is electrically connected to a pad electrode 1e via the IC 1d, and a metal post 1g in a pillar-shape made from copper and formed on the rewiring 1f are provided. On the principle surface 1c, a resin layer (molding resin) 1h is formed and this resin layer 1h molds the IC 1d, rewiring 1f and the metal post 1g. On this resin layer 1h, another surface 1i is formed so as to be in parallel with a surface contacting the principal surface 1c of the wafer 1, and an upper surface of the metal post 1g is exposed so as to be positioned on the same plane as another surface 1i of the metal post 1g.

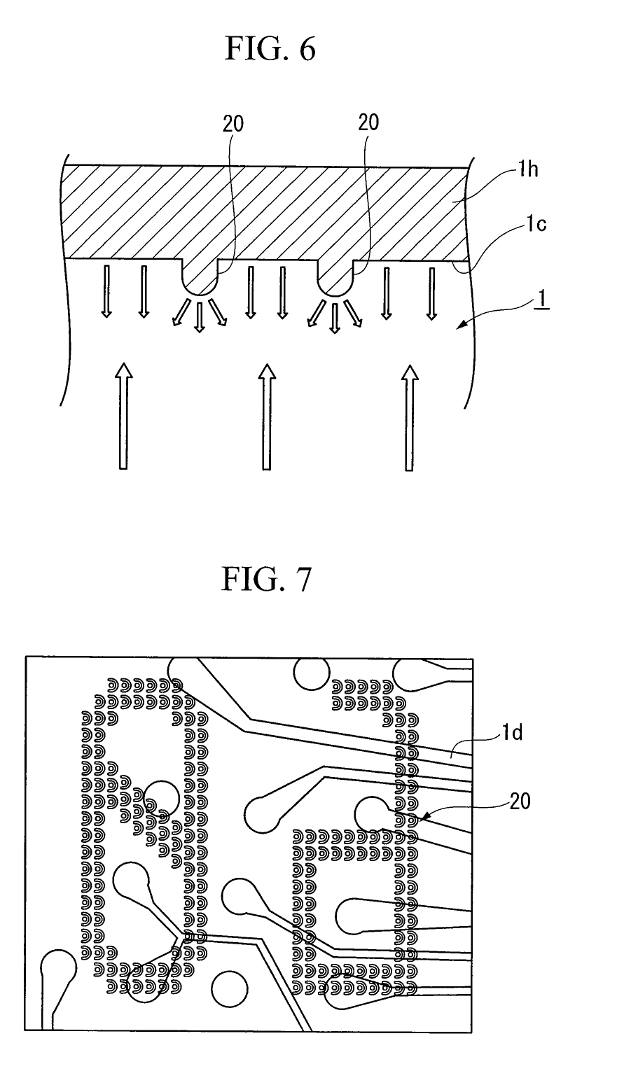

On the other hand, with respect to this wafer 1, on a portion of an outside surrounding portion on the principle surface 1c, for example, as shown in FIG. 6-7, an identification mark 20 including a lot number, a wafer number, and the like is formed. This identification mark 20 is formed in a concave shape by using, for example, a laser marker, and the identification mark 20 indicates a character or a number by applying a set of carved stamps in a dotted shape. A diameter of one dot of the identification mark 20 is approximately, for example, 20-500 μm. On this wafer 1, at a position on the outside surrounding portion opposite to the identification mark 20, is a notched V shape, and this notch portion is a notch 1a which is a mark for identifying a position of the wafer 1. It should be noted that a checked or grid portion on the principle surface 1c of the wafer 1 shown in FIG. 4 indicates a dicing line 23 which is used upon cutting a semiconductor device 22 into pieces by dicing, and a square portion surrounded by this dicing line 23 is one of the semiconductor device 22.

The identification mark 20 which is formed on the principle surface 1c of the wafer 1 in such a manner is, as shown in FIG. 5, covered by the resin layer 1h completely when the principle surface 1c is molded by the resin layer 1h; therefore, it is impossible to recognize the identification mark 20 by the naked eye or, for example, by using a CCD camera which receives reflected light and obtains an image upon radiating the visible ray. Therefore, there is a problem in which it is impossible to recognize or identify the wafer 1 after molding with the resin.

Hereinafter, a method of reading the identification mark 20 formed on the wafer 1 by using a reading apparatus A constituted in the above-described manner for reading the identification mark 20 is explained.

First, the first container case 5 containing multiple wafers 1 is mounted on the first container case mounting table 6 and the empty second container case 7 is mounted on the second container case mounting table 8. The bifurcated end portion of the third arm 17c is inserted inside the first container case 5 by driving the transportation portion 9, the supporting portion 18 is arranged so as to contact on the back face 1b of one of the wafers 1 which is transported, and the wafer 1 is obtained or fixed at the supporting portion 18 by suction.

The wafer 1 which is obtained or fixed by suction is taken out of the first container case 5 and is transported onto the stage portion 2. The suction portion 2f protrudes out of the aperture portion 2c of the stage portion 2, the suction pad 2e is contacted at an approximately center position of the wafer 1 which is maintained by the third arm 17, and the wafer 1 is maintained by suction by driving the vacuum suction means which is connected to the suction main body portion 2d. In this step, after releasing suction of the supporting portion 18 of the third arm 17c, the transportation portion 9 is returned to its original position. At this time, transporting and receiving of the wafer from the first container case 5 to the stage portion 2 is finished.

On the other hand, in this step, the wafer 1 maintained by the suction portion 2f is in a state in which it is not possible to recognize a position of the identification mark 20. Therefore, along with taking an external image of the wafer 1 by using the first imaging portion 3, the wafer position recognition apparatus 3b recognizes a position of the wafer 1 based on an outside edge of the wafer 1 and a position of the notch 1a. When a current position of the wafer 1 is recognized, the suction portion 2f is rotated around an axis line O1 and the wafer 1 is transported so as to arrange the notch 1a at a predetermined position. While suction of the suction pad 2e is reduced, the suction portion 2f is returned to the aperture portion 2c of the stage portion 2 and the wafer 1 is mounted on the upper surface 2a of the stage portion 2. The wafer 1 which is mounted in such a manner is mounted so as to overlap both a position at which the identification mark 20 is formed and at the groove portion 2h of the stage portion 2.

Infrared is radiated from the IR light source 10 of the second imaging portion 4. This infrared is radiated from the second edge of the fiber bundle 11 and reflected by the reflection mirror 12. The direction of the optical axis of infrared is changed by the reflection mirror 12 so as to orthogonally cross the principle surface 1c of the wafer 1 and infrared is radiated on the back face 1b of the wafer 1 via the groove portion 2h of the stage portion 2.

Infrared which is radiated on the back face 1b of the wafer 1 has a wavelength of 1100 nm or longer; therefore, infrared transmits the wafer 1. There is a smaller ratio of the transmitted infrared in this wavelength band which is spoiled by the resin layer 1h or which is transmitted through the resin layer 1h, and a large portion of the infrared is reflected at a contacting boundary surface between the resin layer 1h and the wafer 1. The reflected infrared (reflected light) transmits through the wafer 1 again, passes out of the wafer 1, passes through the reflection mirror 12 which is a half mirror, is received and condensed by the lens 16 of the IR camera, and forms an image at the imaging device 15. In accordance with such a manner, the identification mark 20 which is formed on the principle surface 1c of the wafer 1 is obtained and is displayed on the display portion 16b which is connected to the imaging device 15 via the wiring. By recognizing this displayed image, it is possible to read the identification mark 20 on the wafer 1 after forming the resin layer 1h.

In this embodiment, the infrared is radiated on the wafer 1 along with setting the direction of its optical axis orthogonally so as to cross the principle surface 1c of the wafer 1; therefore, as shown in FIG. 6, the reflected light reflected by the approximately flat principle surface 1c except for the light reflected by the identification mark 20 in a concave shape obtains its optical axis so as to be in a direction orthogonal to the principle surface 1c. On an image taken by the IR camera 16 which is arranged to have an optical axis of its optical system in an orthogonal direction to the principle surface 1c, for example, as shown in FIG. 7, a pattern of the IC 1d or the like which is formed close to the identification mark 20 on the principle surface 1c is included in the same image.

In a step after finishing obtaining the image including the identification mark 20, the wafer 1 is contacted with the suction portion 2f of the suction pad 2e and is maintained by suction again, and the wafer 1 is passed to the transportation portion 9. By the transportation portion 9, the wafer 1 is contained at the slot of the second container case 7 which is mounted on the second container case mounting table 8. At this time, the wafer 1 is contained at the predetermined slot corresponding to the identification mark 20 which is read. With respect to the multiple wafers 1 of the first container case 5, by repeating the same operation above, the multiple wafers 1 are contained and arranged in the second container case 7, for example, in an ascending or a descending order of the identification mark 20.

In accordance with the reading method and the reading apparatus A of the identification mark 20 formed on the wafer 1, by providing the lighting unit 13 which can radiate the infrared, it is possible to radiate the infrared and to transmit the radiated infrared through the wafer 1, and it is possible to reflect the infrared at the contacting boundary surface between the resin layer 1h and the principle surface 1c of the wafer 1. By providing the IR camera (imaging unit) 16 which can take images along with receiving the reflected light of the infrared, it is possible to receive the reflected infrared and form an image. In accordance with such a manner, it is possible to obtain the image of the principle surface 1c of the wafer 1 by radiating the infrared from a side of the back face 1b of the wafer 1, and it is possible to read the identification mark 20 formed on the principle surface 1c. Therefore, it is possible to read the identification mark 20 with respect to the wafer 1 on which the resin molding is operated, and it is possible to recognize the wafer 1 or the lot.

By providing the reflection mirror 12, it is possible to arrange a direction of the optical axis of the infrared irradiated on the wafer 1 in accordance with needs or requirements. Therefore, it is possible to arrange a setting position of the IC light source 10 in accordance with needs or requirements.

It should be noted that the present invention is not limited to the above-described first embodiment, and it is possible to change the present invention appropriately if it is inside the scope of the present invention. For example, in this embodiment, the reading apparatus A of the identification mark is constituted from: the stage portion 2; the first imaging portion 3; the second imaging portion 4; the first container case mounting table 6; the second container case mounting table 8; and the transportation portion 9; however, a constitution in which at least the second imaging portion 4 is provided is possible. The second imaging portion 4 is constituted from both the lighting unit 13 including: the IR light source 10; the fiber bundle 11; and the reflection mirror 12 and the IR camera 16 including: the lens 14; and the imaging device 15; however, a constitution in which the lighting unit 13 provides at least the IR light source 10 is possible. In such a case, for example, it is possible to apply a constitution in which a lens that receives and condenses the infrared radiated from the IR light source is provided and the infrared is radiated on the wafer 1 via this lens.

In relation to these changes, it is possible to apply a structure in which the second imaging portion 4 is provided in another apparatus such as an external test apparatus which is set among production steps of the semiconductor device, and it is possible that the identification mark 20 is read upon operating an external test by using the existing stage portion such as the external test apparatus or the container case mounting table. Moreover, the first imaging portion 3 of this embodiment is provided for recognizing the position of the wafer 1; however, it is possible to apply the obtained image for operating the external test or for reading the identification mark 20 of the wafer 1 before forming the resin layer 1h.

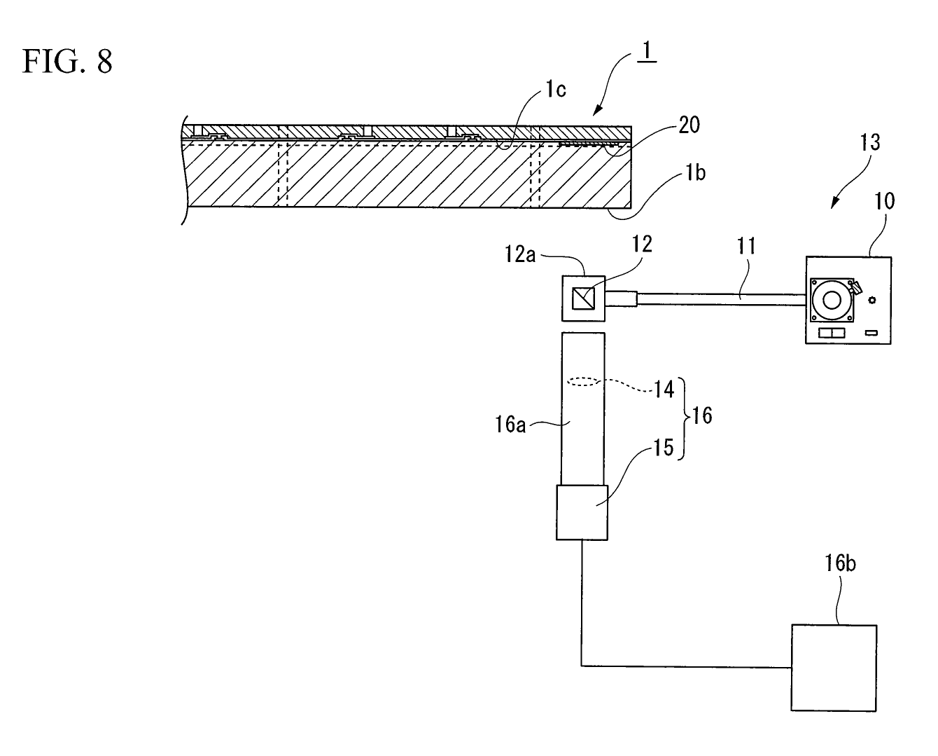

The IR light source 10 of the lighting unit 13 is arranged inside a case which is in a rectangular shape such as a box, and with respect to the IR camera 16, inside the case 16a which is formed in a cylindrical shape, both the lens 14 and the imaging device 15 are arranged; however, it is not needed to provide a limitation of the shape of the cases. Moreover, in this embodiment, the reflection mirror 12 of the lighting unit 13 is provided inside the case 16a of the imaging unit 16; however, in a case in which the reflection mirror is used, for example, as shown in FIG. 8, it is possible to form the reflection mirror 12 in one body which is provided via a second end of the fiber bundle 11 of the lighting unit 13 and to independently provide the reflection mirror 12 and the imaging unit 16. In this case, it is possible to read the identification mark 20 by arranging the reflection mirror 12 between the imaging unit 16 and the wafer 1 along with maintaining the optical axis of the infrared which is polarized by the reflection mirror 12 so as to cross the principle surface 1cof the wafer 1. Moreover, it is possible that the reflection mirror 12 be a half mirror if the reflection mirror 12 is not set on the optical axis of the optical system of the imaging unit 16.

In this embodiment, the imaging unit 16 is arranged to have its optical axis so as to orthogonally cross the back face 1b of the wafer 1; however, it is possible that the imaging unit be provided so as to cross its optical axis to the principle surface 1c of the wafer 1.

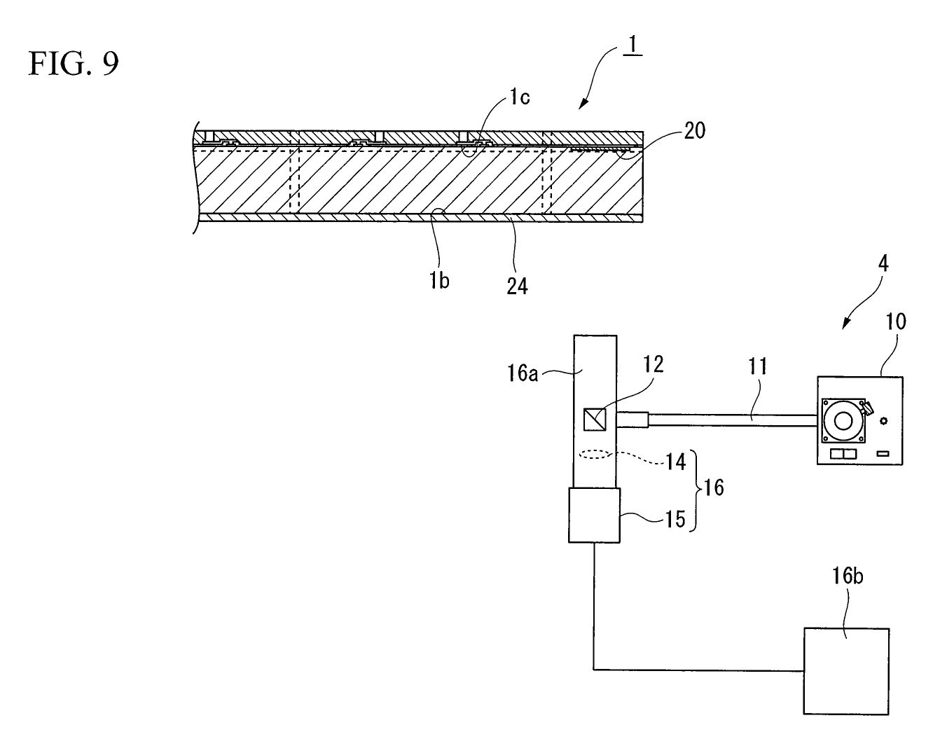

In this embodiment, it is explained that the wavelength of the infrared radiated from the IR light source 10 is 1100 nm or more; however, it is possible if the light is in an infrared band and it is not needed to have a limitation of being 1100 nm or more. Moreover, it is explained that the wafer 1 is formed from a poly-crystal or single-crystal silicon; however, the wafer 1 is not needed to have a limitation of silicon. Additionally, in the present invention, for example, as shown in FIG. 9, with respect to the wafer 1 on which a dicing tape 24 is adhered on the back face 1b or to the wafer 1 which is maintained by the dicing tape 24 after dicing, it is possible to read the identification mark 20 by transmitting the infrared radiated from the lighting unit 13 on the principle surface 1c through the dicing tape 24.

Moreover, it is explained that the diameter of each dot of the identification mark 20 formed on the wafer 1 is approximately 20-500 μm; however, in the present invention, it is sufficiently possible to read the identification mark 20 formed in a smaller diameter than this dot diameter.

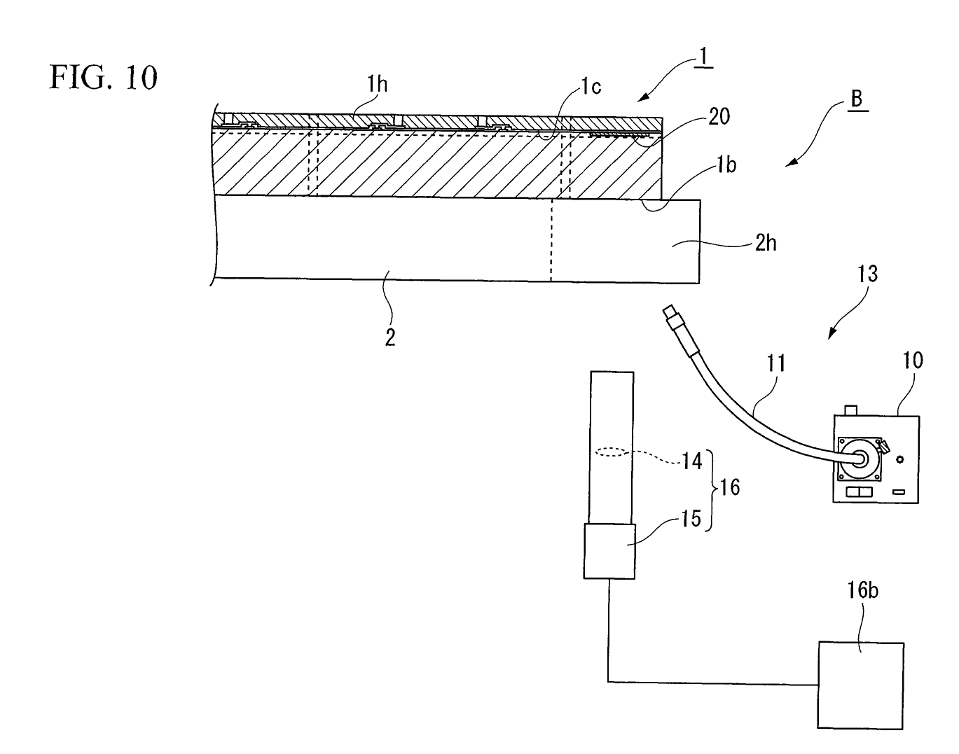

In reference to FIG. 10, a reading method and an apparatus for the same of an identification mark of a second embodiment of the present invention are explained. In an explanation of this embodiment, the same signs and numerals are applied to the same constitutional elements between the first and the second embodiments, and a detailed explanation of them is omitted.

A reading apparatus B of the identification mark 20 of this embodiment, with respect to a constitution of the second imaging portion 4, has only one difference from the first embodiment, and other constitutions are the same. The second imaging portion 4 is constituted from, as shown in FIG. 10, both a lighting unit 13 including: IR (Infra-red) light source 10 (light source) which can, for example, radiate infrared of 1100 nm or more; and a fiber bundle 11 which regulates an optical path of the infrared radiated from the IR light source 10, and an IR camera 16 (imaging unit) including: a lens 14; and an imaging device 15.

The IR light source 10 of the lighting unit 13 is arranged inside a case which is in a rectangular shape such as a box, the fiber bundle 11 has a first edge arranged inside the case so as to make it possible to receive the outgoing infrared from the IR light source 10, and a second edge is extends or protrudes outside the case so as to outgo the infrared received from the first edge. Moreover, the fiber bundle 11 has a flexible structure in which it is possible to change a direction and a position of the second end in accordance with needs or requirements.

A reading method of the identification mark 20 by using the reading apparatus B of the identification mark 20 formed on the wafer 1 in accordance with the above-described structure is explained.

The same as the first embodiment, at a step of mounting the wafer 1 on the stage portion 2, the IR light source 10 radiates the infrared and the infrared passes out of the second end of the fiber bundle 11 onto the back face 1b of the wafer 1. In this step, the fiber bundle 11 is changed in position and direction in accordance with needs and requirements, and the optical axis of the infrared passing out of the second end is controlled so as to diagonally cross the principle surface 1c of the wafer 1.

The same as the first embodiment, the infrared radiated on the back face 1b of the wafer 1 has a wavelength of 1100 nm or longer; therefore, the infrared transmits through the wafer 1 and is reflected on the contacting boundary surface between the resin layer 1h and the wafer 1. The reflected infrared (reflected light) transmitted through the wafer 1 again is received and concentrated by the lens 14 of the IR camera 16, and forms an image on the imaging device 15. In accordance with such an operation, an image showing the identification mark 20 is displayed on the display portion 16b and it is possible to identify the wafer 1.

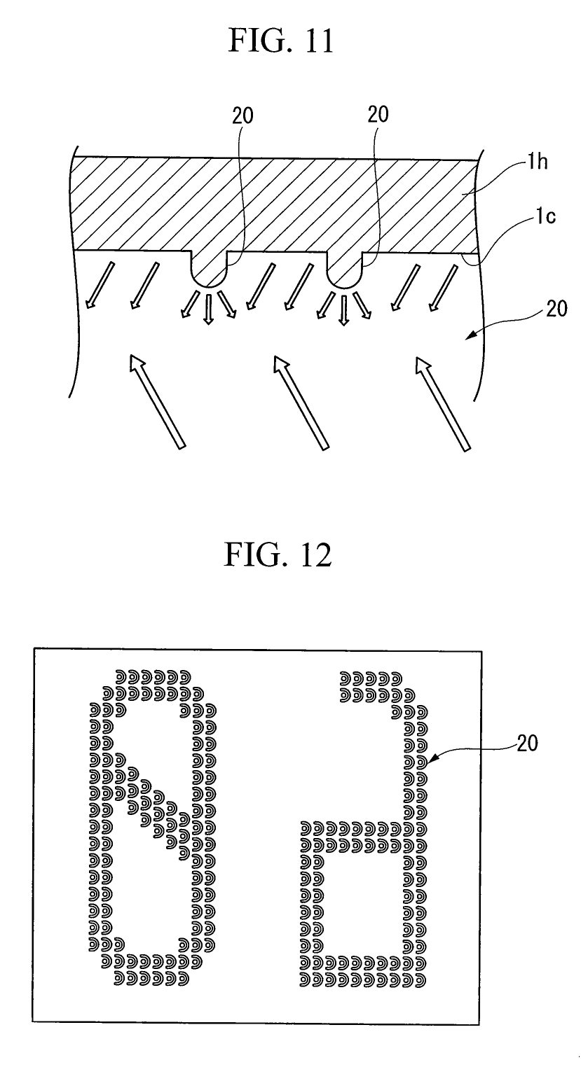

In this embodiment, the optical axis of the infrared has a direction which diagonally crosses the principle surface 1c of the wafer 1 by using the fiber bundle 11 with a flexible structure; therefore, as shown in FIG. 11, the light is regularly reflected by the approximately flat principle surface 1c except for the identification mark 20 which is in a concave shape. On the other hand, with respect to the identification mark 20 which is a set of the dots in concave shapes, the irradiated infrared is diffused in accordance with the concave shape. In this embodiment, the IR camera 16 is arranged so as to set the optical axis of its optical system in a direction orthogonal to the principle surface 1c; therefore, the IR camera 16 does not receive the reflected light which is regularly reflected on the principle surface 1c except for the identification mark 20, and receives and takes an image of only the reflected light which is reflected in a direction of the optical axis of the IR camera 16 and which is included in the reflected light that is diffused by the identification mark 20. Therefore, in the obtained image, for example, as shown in FIG. 12, it is different from the first embodiment in that, a pattern of the IC 1d or the like which is formed close to the identification mark 20 on the principle surface 1c is not included, and only the identification mark 20 is clearly shown.

Therefore, in accordance with the reading method and the reading apparatus B of the identification mark 20 above, it is possible to read the identification mark 20 on the wafer 1 by radiating the infrared which passes out of the fiber bundle 11 of the lighting unit 13 directly on the wafer 1 and by taking an image of the reflected light with the IR camera 16. In accordance with such a manner, it is possible to read the identification mark 20 even in a case in which it is not possible to be recognized by eyes or the CCD camera because the resin layer 1h is formed, therefore, it is possible to recognize the wafer 1 or the lot.

It is possible to radiate the infrared in a direction of the optical axis that diagonally crosses the principle surface 1c of the wafer 1; therefore, it is possible to receive the reflected light which is diffused by the identification mark 20 and to obtain the image, by arranging the IR camera 16 in order to set the optical axis of the optical axis of the IR camera 16 so as not to be the same as an optical axis of the reflected light which is regularly reflected on the principle surface 1c in an approximately flat shape except for the reflected light reflected by the identification mark 20. Therefore, it is possible to obtain an image in which, for example, a pattern of the IC 1d or the like is not included, and only the identification mark 20 is clearly shown.

It should be noted that the present invention is not limited to the above-described second embodiment, and it is possible to change the present invention appropriately if it is inside the scope of the present invention. For example, in this embodiment, the optical axis of the infrared which passes out of the second end of the fiber bundle 11 of the lighting unit 13 diagonally crosses the principle surface 1c of the wafer 1; however, this is not a limitation and, the same as in the first embodiment, it is possible to radiate so as to orthogonally cross the principle surface 1c of the wafer 1. Moreover, it is explained that the imaging unit 16 is arranged so as to set the optical axis of the optical system of the imaging unit 16 orthogonal to the principle surface 1c of the wafer 1; however, it is possible that the imaging unit be also arranged in order to set the optical axis so as to diagonally cross the principle surface 1c of the wafer 1. In this case, by setting the optical axis of the reflected light which is regularly reflected by the principle surface 1c except for the identification mark 20 at a position shifted or slid from the optical axis of the imaging unit 16, it is possible to obtain an image on which the identification mark 20 described in this embodiment is clearly shown.

In accordance with the reading method of the identification mark of the present invention, by radiating infrared from a side of the back face of the wafer, it is possible to transmit infrared through the wafer and to reflect the infrared at the contacting boundary surface between the principle surface and the resin layer on which the IC, the rewiring, the electrode terminals and the like are molded on a side of the principle surface of the wafer. Therefore, by imaging along with receiving the reflected light of infrared, it is possible to read the identification mark formed on the principle surface and which cannot be read in accordance with the prior art at a step after molding with the resin layer.

In accordance with the reading method of the identification mark of the present invention, by radiating infrared along with diagonally crossing the optical axis on the principle surface of the wafer, it is possible to obtain a fine and clear image of the identification mark formed in a concave shape on the principle surface by using, for example, a laser marker or the like. In other words, the principle surface except for the identification mark is in an approximately flat state, therefore, infrared is mostly and regularly reflected; however, with respect to the identification mark which is a set of dots in a concave shape, the reflected infrared is diffused in accordance with the concave shape. Therefore, for example, if infrared is radiated from a direction which is orthogonal to the principle surface, the reflected light goes in a direction which is orthogonal to the principle surface; and therefore, the image of the received light includes both the identification mark and, for example, a pattern of the IC and the like formed on the principle surface. On the other hand, in a case of diagonally radiating infrared on the principle surface, it is possible to receive the diffused light in accordance with the concave shape of the identification mark without receiving the light regularly reflected on the principle surface except for the identification mark; therefore, it is possible to obtain an image on which almost only the identification mark is shown by receiving and imaging the diffused light.

In accordance with the reading apparatus of the identification mark of the present invention, by providing both the lighting unit which radiates infrared and the imaging unit which receives and takes an image of the infrared reflected from the wafer, it is possible to transmit infrared through the wafer radiated by the lighting unit from the back side of the wafer and to take an image of the infrared reflected at the principle surface of the wafer by using the imaging unit. Therefore, it is possible to read the identification mark formed on the principle surface of the wafer.

With respect to the reading apparatus of the identification mark of the present invention, the fiber bundle is provided at the lighting unit; therefore, it is possible to arrange the light source at a desired position, and moreover, it is possible to radiate infrared along with turning or facing the optical axis to the desired direction. Therefore, it is possible to selectively take an image in which only the identification mark is shown, or in which, for example, the IC pad electrode, the rewiring, and/or the like formed on the principle surface are shown in addition to the identification mark.

With respect to the reading apparatus of the identification mark of the present invention, the reflection mirror which regulates the optical path of infrared is provided; therefore, it is possible to turn or face the optical axis of infrared passing out of the light source to the desired direction by adjusting its setting angle, and it is possible to set the light source at a desired position; and therefore, it is possible to selectively take an image in which only the identification mark is shown, or in which, for example, the IC pattern electrode, and/or the like formed on the principle surface are shown in addition to the identification mark.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A reading method of an identification mark which is formed on a wafer comprising the steps of:
radiating infrared which has an optical axis crossing the wafer from a side of a back face of the wafer on which a resin layer which molds a side of a principle surface is formed; and
reading the identification mark formed on the side of the principle surface of the wafer by imaging the identification mark along with receiving reflected light of the infrared.

2. A reading method of an identification mark according to claim 1, wherein the infrared is radiated along with diagonally crossing the optical axis on the principle surface of the wafer.

3. A reading apparatus of an identification mark formed on a wafer including a resin layer which molds a principle surface of the wafer, comprising:
a lighting unit which radiates infrared; and
an imaging unit which obtains an image by receiving reflected light of the infrared radiated on the wafer from the lighting unit.

4. A reading apparatus of an identification mark according to claim 3, wherein the lighting unit comprises a fiber bundle which regulates an optical path of the infrared radiated from a light source.

5. A reading apparatus of an identification mark according to claim 3, further comprising a reflection mirror which regulates the optical path of the infrared radiated from the light source.
